(19) United States
(12) Patent Application Publication
(10) Pub. No.: US 2026/0257914 A1
(43) Pub. Date: Sep. 3, 2026

(54) RECYCLING TELLURIUM AND OTHER MATERIALS UTILIZED IN TEG MANUFACTURING

(71) Applicant: ATS IP, LLC, Fort Collins, CO (US)

(72) Inventors: Ion BASA, Fort Collins, CO (US); Jake PEREZ, Fort Collins, CO (US); John NEWMAN, Fort Collins, CO (US); Ronald PETKIE, Fort Collins, CO (US); Kelly ADAMS, Edmonton (CA)

(21) Appl. No.: 18/846,856

(22) PCT Filed: Mar. 30, 2023
(86) PCT No.: PCT/US2023/016815

§ 371 Date: Sep. 13, 2024

(51) Int. Cl. C01B 19/02

(52) U.S. Cl. CPC C01B 19/02; C01P 2006/40

(57) ABSTRACT

The recycling embodiments herein provide cyclical manufacturing of bulk semiconductor materials. In one embodiment, a method for recycling materials used in a semiconductor manufacturing process (e.g., a TEG manufacturing process) includes cutting one or more semiconductor wafers into a plurality of semiconductor components, and retrieving waste materials resulting from said cutting. The method also includes forming an ingot of semiconductor manufacturing material (e.g., tellurium) from the waste materials, and zone melting the ingot to remove impurities from the ingot.

### CROSS REFERENCE TO RELATED APPLICATIONS

This patent application claims priority to, and thus the benefit of an earlier filing date from, U.S. Provisional Patent Application No. 63/326,675 (filed Apr. 1, 2022), the contents of which are hereby incorporated by reference.

### BACKGROUND

Tellurium is a rare metal that is used in the production of clean energy components including solar panels and thermoelectric devices, such as thermoelectric generators (TEGs). With worldwide goals for clean energy and carbon footprint reduction, demands for this material and other rare metals used in clean energy manufacturing will increase significantly. As demand grows, both bismuth and tellurium will rapidly be in short supply. Ironically, recycling tellurium-based products is a manufacturing process missing from the creation of clean energy technology.

Physical device manufacturing of a TEG may begin with a tellurium-based thermoelectric material that is doped as either negative or positive by use of selenium or antimony, respectively. This material may then be formed into wafers using a wafer process that creates a polycrystalline material. Following the waferization process, the wafers are metallized and then diced to be placed into TEGs. The metallization provides a surface for the solder to bond to the semiconductor. This metalization typically uses copper, nickel, gold, palladium, tin, titanium, and or ruthenium-based layer(s). Metalization can occur by plating (e.g., electroless and electrolytic), or by deposition. During dicing, a relatively large amount of kerf loss (e.g., typical of at least 20%) is experienced for a 4-inch diameter wafer. This kerf loss includes material loss due to the width of the dicing blade and edge loss from the perimeter of the wafer. This material is unable to be used in the TEGs and is generally stored for later disposal.

Tellurium is one of the least common elements on the planet. This scarcity has caused concerns with tellurium-based semiconductors in that it drives costs higher, slows production times, and a limits ability to make semiconductors. It is important to recover any excess tellurium-based semiconductor and return it to a useable state.

### SUMMARY

Systems and methods presented herein provide for the recycling of semiconductor materials, such as tellurium. In one embodiment, a method for recycling materials used in a semiconductor manufacturing process (e.g., a TEG manufacturing process) includes cutting one or more semiconductor wafers into a plurality of semiconductor components, and retrieving waste materials resulting from said cutting. The method also includes forming an ingot of semiconductor manufacturing material (e.g., tellurium) from the waste materials, and zone melting the ingot to remove impurities from the ingot.

In some embodiments, the method may also include adding tellurium to the retrieved waste materials to obtain a predetermined chemical balance of tellurium. The method may also include removing at least one of metals, solder, or diffusion layers from the waste materials via a chemical bath and/or via a mechanical abrasion. The method may also include preparing the ingot for subsequent semiconductor manufacturing use by grinding and homogenizing the ingot into a powder. The method may also include performing an x-ray diffraction and inductively coupled plasma mass spectrometry on the powder to determine purity of the powder.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 illustrates one exemplary semiconductor manufacturing and recycling.

FIG. 2 is a flowchart of an exemplary process of the manufacturing and recycling of FIG. 1.

FIG. 3 is a block diagram of a machine learning system operable to determine semiconductor material purity upon recycling.

### DETAILED DESCRIPTION

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

Systems and methods presented herein provide for the recycling of semiconductor materials, such as tellurium used in TEG manufacturing, from old and damaged projects, kerf losses, and materials rejected from quality assurance processes. This goal combined with an overarching mission of creating clean energy solutions addresses concerns regarding carbon footprint reduction and scarcity of manufacturing materials for sustainable energy devices. In this regard, the systems and methods presented herein provide for developing a circular manufacturing and recycling program.

One manufacturing process begins via COMSOL. COMSOL Multiphysics is a computer software package used for modeling, simulating, and analyzing scientific and engineering problems involving complex physics phenomena. COMSOL allows users to create virtual models of physical systems and simulate how they would behave under different conditions. COMSOL supports the modeling of various physical phenomena, including structural mechanics, fluid dynamics, electromagnetics, heat transfer, chemical reactions, and acoustics, among others. Some of COMSOL's applications include designing and optimizing microelectromechanical systems (MEMS), analyzing the performance of optical devices, simulating the behavior of fluid flow in pipelines, predicting the properties of materials, and modeling the behavior of biological systems, and/or designing and modeling thermoelectric generators (TEGs).

Using this process, the physical properties of materials and the best manufacturing route can be observed. Physical manufacturing may begin with a tellurium-based material that is doped as both negative and positive. This material may then be formed into wafers using a non-traditional wafer process that creates a polycrystalline material via Spark Plasma Sintering (SPS) or Field Assisted Sintering Technology (FAST). SPS/FAST is a wafer forming technique used to create polycrystalline and microstructure thermoelectric wafers. The process is based on an electric current running directly through a pressing die, mold, and the semiconductor powder. The electrical current is pulsed at an extremely fast switching frequency resulting in fast heating and cooling cycles for wafer formation. This fast switching frequency combined with a rapid heating and cooling cycle produces unique structured materials not possible with traditional processing methods and equipment, such as hot pressing or bridgeman ingot growth methods which produce single crystal material instead of polycrystalline material.

Following the waferization process, the wafers are metallized and then diced for placement into TEGs. During dicing (i.e., a semiconductor cutting process), a relatively large amount of kerf loss is experienced (e.g., at least 20%). This kerf loss includes material that is lost due to the width of the dicing blade and edge loss from the perimeter of the wafer. The width of the kerf is generally determined by the thickness of the cutting tool, and the material being cut.

Kerf loss can be significant, especially for materials that are expensive and/or that are rare. Kerf loss represents a critical loss of scarce material, and it impacts the environment due to mining and the like when more of the material is needed. In TEG manufacturing, kerf loss material is unable to be used in the TEGs, and is generally stored for later disposal. Thus, embodiments herein provide for the recapture of lost semiconductor material, such as tellurium-based materials used in subsequent TEG manufacturing.

One path to recycling tellurium-based material involves three processes: (a) stripping and/or reclaiming precious metals from discarded parts; (b) grinding or ball milling the discarded parts into telluride-based powder; and (c) verifying that the resulting telluride based-based powder performs at a level equivalent to virgin telluride based-based powder.

Stripping and/or reclaiming precious metals from discarded parts, old TEG cartridges, kerf losses, and damaged wafers is the first step in recycling tellurium. A mechanical process, a chemical process, and/or a melting process can be used to separate the metallization from the base material. Each option is used depending on the cost, complexity, and goal of the recovery of the telluride based semiconductor and metallization layer. Some elements may contain additional layers between the metallic soldering layer and the thermoelectric elements.

Mechanically stripping the metal can be performed a variety of ways, such as media blasting, sanding, scraping, and other forms of mechanical abrasion. While this process generally cannot recover the metallization layer, it is economical and more readily implemented. However, this process can leave precious metal in cracks, pores, voids, or surface structures of the base. This can have disadvantages including increased remaining impurities and reduced bulk telluride based thermoelectric material.

Chemically stripping involves a reclaiming bath to remove precious metals, such as the base tellurium material. This process allows the base material to retain the desired composition while reducing contaminants and semiconductor material loss. This process can either be initiated with or without electrical means, known as “electroless” or “electrolytic” with the same resultant outcome, and is generally a matter of preference.

Another method includes using melting point separation to separate the semiconductor from the metallization. The melting point of these metals is usually an order of magnitude higher than that of the semiconductor. An inert gas furnace or crucible, or an oxygen free furnace or crucible, can be used for this process. The tellurium-based semiconductor melts while leaving the metal in a solid state. This is due to tellurium having a melting point of approximately 449.5 C while the noble metals used as coatings have a much higher melting point. One disadvantage includes the base semiconductor losing dopants at a higher rate than the aforementioned processes.

An optional step is melting or re-melting a tellurium-based material into an ingot, which would allow the material to have crystal lattices realigned to target the composition of the original raw material. This addresses concerns regarding material misalignment due to the stripping or manufacturing processes. Zone melting of the ingot can purify the material by moving contaminants out of the bulk material.

Grinding or ball milling (e.g., and/or cryogenic-milling processes) may then be performed on the ingot to produce a powder of a desired particle size distribution. After grinding, resultant particle sizes may be measured to ensure the desired particle size is reached for waferization processes (i.e., semiconductor wafer manufacturing).

Each telluride based sample to be reclaimed is first evaluated to determine if precious metals exist on the surface. If no precision metals exist, the stripping step is skipped. If, however, there is metallization on the telluride based sample, it is subjected to a stripping stage. Assuming chemical stripping is used, the semiconductor material is submerged in a chemical bath. This chemical bath contains a non-reactive polypropylene basket to hold numerous samples. During the time each sample is in the chemical bath, the precious metal layers are converted to an ionic state and become part of the chemical bath. Over time the ionic states recombine and precipitate as an un-purified solid out of the solution. This precipitate is then collected for further metal purification and separation, and can be re-introduced to the telluride-based metallization process.

Once all precious metals are removed and only telluride based sample material remains, the samples are evaluated for their percent weight content of tellurium, dopants, and accompanying additional thermoelectric material. Additionally, a subsequent purification step may be performed. One method of purification is zone melting which moves contaminants and excess precipitates out of the bulk material via slow passes melting the material causing impurity migration.

The material may be turned into powder form, then a weight percentage of additional dopants and materials is added back into powder to return the bulk material to the desired chemical compositions. Once the end state formulation is reached, the tellurium-based material is subsequently melted back into a crystal state. This crystal state allows the material to have crystal lattices realigned to target the composition of the original raw material. This addresses concerns regarding material misalignment due to the stripping process or manufacturing process. Material analysis may be re-performed and optionally another purification process may be performed depending on the results of the material analysis.

A second powderization is performed via grinding, ball milling, and/or cryogenic-milling processes. The resulting powder can be of a desired particle size distribution. The desired particle size is obtained by selecting non-reactive mediums for milling, such as stainless-steel balls of a corelated diameter and time at process. After grinding, resultant particle sizes are measured and sifted through a sieve to ensure the desired particle size is reached for the waferization process.

Quality assurance and verification of the newly ground material can include multiple steps. For example, x-ray diffraction and inductively coupled plasma mass spectrometry (ICP-MS) may be used to determine chemical composition to ensure that the powder is contaminate-free. Once the material passes initial quality tests, it may then be cold pressed to measure the material's Seebeck coefficient and resistivity. This is a secondary check of powder performance and is not necessary once composition to wafer performance correlation has been established. This sample wafer is known as a coupon and is used to measure the thermoelectric properties of each recycled batch of material. Following clearance from this step, wafers from this recycled powder can be manufactured, utilizing internal measurement equipment to determine power factors for the resulting wafers.

Confirming the quality and composition of these recycled materials and their corresponding impacts on the performance of future uses is important. Utilizing equipment such as X-ray Powder Diffraction (XRD), Scanning Electron Microscopy (SEM), Electron Backscatter Diffraction (EBSD), four-point probes, etc. to check the performance of the recycled material will give insights into the recycling process. Implementation of tools and processing techniques, such as zone melting, cryo-milling, annealing, and spark plasma sintering can help assure that the recycled material returns to a similar base state.

In this regard, a cyclical manufacturing process can be implemented for bulk tellurium-based products. One factor in understanding and implementing this process is to investigate the purity, particle size, impurity minimization, and performance of recycled materials. This initiative would be able to advance tellurium research and manufacturing with an implementable recycling process.

Following clearance from this step, full scale wafers, now referred to as production wafers, from this recycled powder can be manufactured. These production wafers are verified utilizing internal measurement equipment to determine power factor and by artificial intelligence and/or machine learning to verify production quality and the figure of merit (i.e., zT).

The recycling embodiments herein develop cyclical manufacturing techniques of bulk tellurium-based materials which have not been previously explored or utilized. Advancements made in these processes allow for a base understanding of how tellurium crystal lattice structures are influenced by the recycling process. In addition to observing crystal lattice changes from the recycling process, additional information regarding the material characterization can be developed to understand the thermoelectric effects of recycled material and its usability. These advancements will aid researchers and industries utilizing tellurium-based materials in developing an environmentally friendly recycling method to offset the predicted tellurium shortage in the coming years. The understanding of recycled tellurium crystal latices and material properties allows recycled tellurium-based materials to be used as an alternative to virgin tellurium materials for years to come.

In addition to tellurium, precious metals, such as gold, nickel, tin, and palladium, which are metalized on the thermoelectric semiconductor can also be reclaimed by this process. For example, it is typical to use a layer of gold over a layer of nickel as soldering and anti-oxidation layers on the outermost surfaces of a thermoelectric element. These layers are typically applied to solder metallic interconnects to the thermoelectric elements. These layers can also be recycled using the methods disclosed herein.

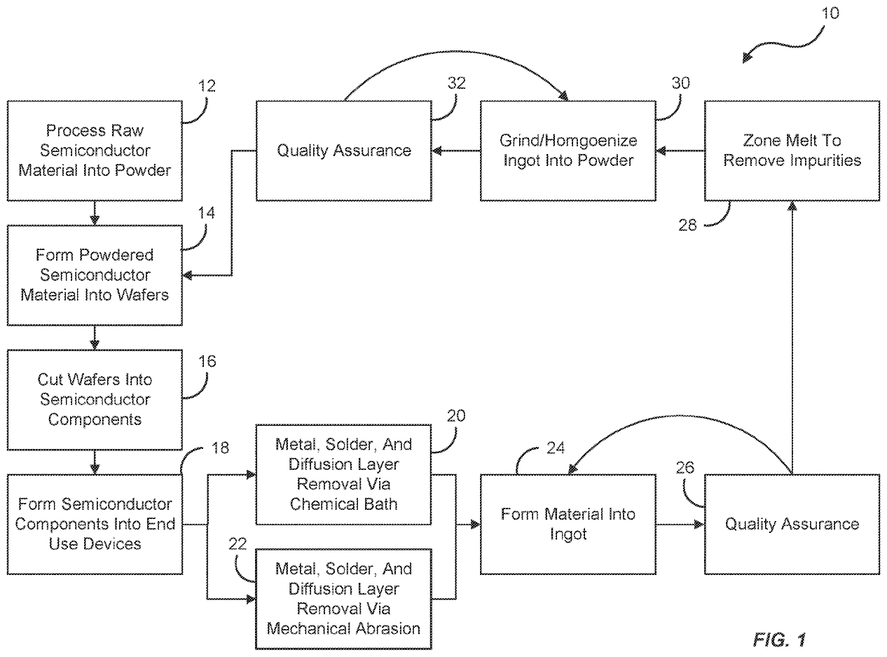

FIG. 1 illustrates one exemplary semiconductor manufacturing and recycling process 10 involving tellurium. In this embodiment, raw material processing of tellurium-based materials is converted into a powder form for manufacturing certain semiconductors, in the process element 12. From there, the materials may be formed into a wafer, in the process element 14, such that individual integrated circuits (e.g., chips) may be formed. With the wafer formed, the individual circuits may be cut into cuboid shapes from the wafer, in the process element 16. As the wafer is typically circular in design, portions of the cuboid shapes will lie off the area of the wafer. And the portions that reside on the wafer are essentially useless as circuits. Thus, when the individual cuboid shaped circuits are cut from the wafer, the portions of the cuboid shaped circuits become waste products. The material separating the individual cuboid shapes on the wafer where the circuits are cut may also result in waste product.

The individual cuboid shaped circuits that are cut from the wafer become manufactured into devices, in the process element 18. The waste product material can, however, be retained and recycled for subsequent use. In this regard, certain materials from the waste product material may be isolated to extract the desired materials for recycling. For example, the waste product material may have metal, solder, diffusion layers, etc. that can be removed by means of a chemical bath, in the process element 20. Alternatively or additionally, these materials may be removed using a mechanical abrasion process, in the process element 22. Melting can also be used. From there, the materials that are deemed recyclable (e.g., tellurium) may be melted or otherwise formed into ingots, in the process element 24, for subsequent use. In this process, similar material may be added to obtain a desired chemical balance for the recycled material. Then, the recycled material may undergo a spectroscopy for quality assurance, in the process element 26.

If the material does not pass quality assurance process, the recycled material may be reprocessed in the process element 24. Otherwise, the ingot may be zone melted (a.k.a. arc melted) to remove impurities from the recycled ingot, in the process element 28. For example, the ingot may be re-melted such that impurities may separate from the desired material. Then, these impurities may be cut from the ingot. From there, the ingot of the recycled material may be ground and homogenized into a powder material, in the process element 30. This powdered material may also go through a quality assurance (e.g., a spectroscopy) to ensure that the recycled material has the desired chemical properties with a desired minimal level of impurities, in the process element 32.

If the powdered recycled material does not meet the desired quality assurance level, the powder may be reground and homogenized, in the process element 30. Otherwise, the recycled material may be used in a subsequent manufacturing process, such as the wafer forming process of process element 14.

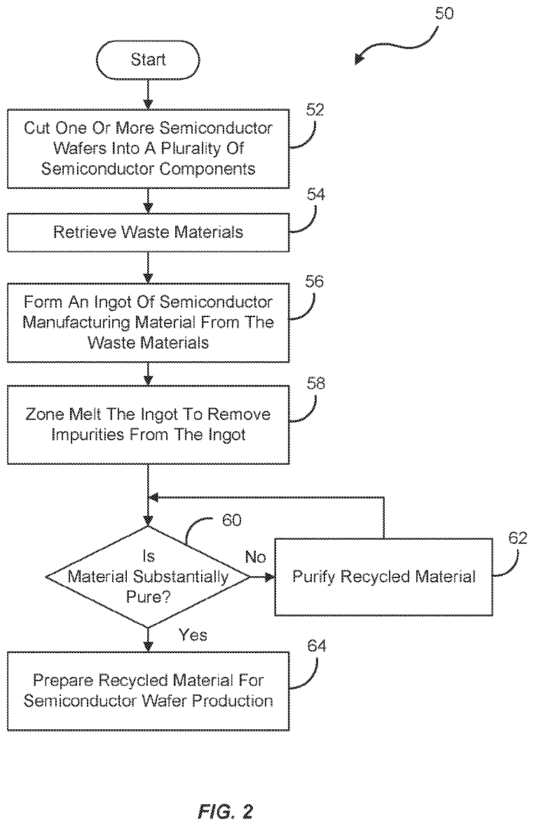

FIG. 2 is a flowchart of an exemplary process 50 of the manufacturing and recycling of FIG. 1. In this embodiment, the process 50 initiates when one or more semiconductor wafers are cut to a plurality of semiconductor components, in the process element 52. For example, semiconductors are typically manufactured from semiconductor materials that are shaped into wafers. Then, individual semiconductor components (e.g., processors, computer chips, etc.) are cut from the wafers. This cutting process results in accumulated waste materials.

The process 50 then retrieves the waste materials, in the process element 54. This may include isolating the waste materials into different material types (e.g., through mechanical abrasion, chemical stripping, etc.). Then, a desired material, such as tellurium, may be melted and formed into an ingot, in the process element 56. The ingot may be zone melted to remove impurities from the ingot, in the process element 58.

Once the impurities have been removed, a quality assurance process may be implemented to determine whether the material is substantially pure, in the process element 60. For example, the ingot may undergo x-ray diffraction and inductively coupled plasma mass spectrometry to determine the amount of the desired material in the ingot. Alternatively or additionally, such a quality assurance process could be performed after the ingot is prepared for subsequent semiconductor manufacturing. In any case, if the material is not substantially pure, the process may attempt to purify the material, in the process element 62, until a desired level of purity is reached (e.g., via additional melting, zone melting, additive material, etc.). Otherwise, once the material has reached the desired level of purity, the material is prepared for semiconductor wafer production, in the process element 64.

In some embodiments, the recycling process may employ scanning electron microscope (SEM) imagery, energy-dispersive spectroscopy (EDS/EDAX) imagery, and/or electron backscatter diffraction (EBSD) imagery to determine the crystallographic orientation and chemical composition (e.g., purity) of recycled ingots. In this regard, the embodiments herein could also use AI and/or ML to import large image datasets obtained via SEM, EDAX, and/or EBSD and employ algorithms to determine crystallographic orientation and chemical composition of newly recycled ingots.

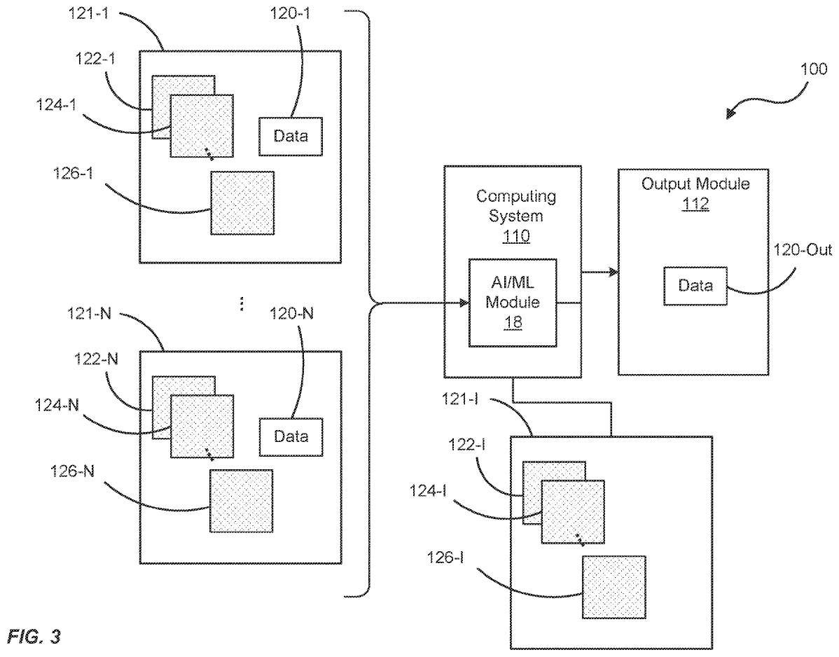

FIG. 3 is a block diagram of another exemplary a system 100 for machine learning crystallographic orientation, chemical composition, and/or other features of recycled ingots. In this embodiment, the system 100 is operable to process a plurality of data/image sets 121-1-121-N to train the AI/ML module 18. The AI/ML module 18 is implemented in a computing system 110 (e.g., using parallel processing graphics cards, computer processors, computer memory, etc.).

Each of the data/image sets 121 includes at least one SEM image 126 of a recycled ingot, and possibly other images of the ingot, such as EDS/EDAX imagery 122, EBSD imagery 124. The data/image sets 121 also include data 120 pertaining to recycled ingot (e.g., crystallographic orientation, chemical composition, etc.). The data/image sets 121 are used to train the AI/MI module 18. Once the AI/ML module 18 has been trained, the computing system 110 may input a data/image set 121-I of another ingot to the AI/ML module 18 for feature extraction. Once the features of the other ingot have been learned by the AI/ML module 18, the output module 112 may output the SEM image 126-I with the learned data 120-Out (e.g., crystallographic orientation, chemical composition, etc.).

The AI/ML module 18 may be implemented in a variety ways as a matter of design choice. For example, the AI/ML module 18 may employ one or more of a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network, a convolutional neural network, a transfer learning algorithm, an association rules algorithm, or the like. Accordingly, the systems 10 and 100 are not intended to be limited to any particular semiconductor wafer feature learning algorithm. Additionally, while the terms AI and ML may represent different ways of approaching computationally learned aspects of semiconductor wafers, the two terms may be represented and claimed herein collectively as ML, or machine learning.

Any of the above embodiments herein may be rearranged and/or combined with other embodiments. Accordingly, the concepts herein are not to be limited to any particular embodiment disclosed herein.

What is claimed is:

1. A method for recycling materials used in a semiconductor manufacturing process, comprising:
cutting one or more semiconductor wafers into a plurality of semiconductor components;
retrieving waste materials resulting from said cutting;
forming an ingot of semiconductor manufacturing material from the waste materials; and
zone melting the ingot to remove impurities from the ingot.

2. The method of claim 1, wherein forming an ingot further comprises:
adding tellurium to the retrieved waste materials to obtain a predetermined chemical balance of tellurium.

3. The method of claim 1, wherein forming an ingot further comprises:
melting the retrieved waste materials to form the semiconductor manufacturing material into a crystalline state.

4. The method of claim 1, further comprising:
removing at least one of metals, solder, or diffusion layers from the waste materials via a chemical bath.

5. The method of claim 1, further comprising:
removing at least one of metals, solder, or diffusion layers from the waste materials via a mechanical abrasion.

6. The method of claim 1, further comprising:
preparing the ingot for subsequent semiconductor manufacturing use by grinding and homogenizing the ingot into a powder.

7. The method of claim 6, further comprising:
performing an x-ray diffraction and inductively coupled plasma mass spectrometry on the powder to determine a purity of the powder.

8. The method of claim 1, wherein:
the semiconductor manufacturing material includes tellurium.
